(19) United States
(12) Patent Application Publication
(10) Pub. No.: US 2009/0029147 A1
(43) Pub. Date: Jan. 29, 2009

(54) AEROGEL-FOAM COMPOSITES

(75) Inventors: Yuehua Tang, Boylston, MA (US); Andrew Polli, Ellicott City, MD (US); Carl J. Bilgrien, Boylston, MA (US); Donald R. Young, Brookline, MA (US); Wendell E. Rhine, Belmont, MA (US); George L. Gould, Mendon, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS, INC., Northborough, MA (US)

(21) Appl. No.: 11/761,924

(22) Filed: Jun. 12, 2007

Related U.S. Application Data
(60) Provisional application No. 60/812,798, filed on Jun. 12, 2006.

(51) Int. Cl. B32B 3/26; C08J 9/00; C08G 18/00; C08J 9/28

(52) U.S. Cl. 428/319.1; 521/50; 521/142; 521/155; 521/64; 428/221

(57) ABSTRACT

The invention provides reinforced aerogel monoliths as well as reinforced composites thereof for a variety of uses. Compositions and methods of preparing the monoliths and composites are also provided. Application of these materials in transparent assemblies is also discuss.

### CROSS-REFERENCES TO RELATED APPLICATIONS

This application claims benefit of priority from U.S. Provisional Patent Application 60/812,798 filed Jun. 12, 2006 which is incorporated herein by reference in its entirety as if fully set forth.

### FIELD OF THE INVENTION

The inventions described herein relate to aerogel-foam composites, particularly composites of aerogel and reticulated foam, and their production. Translucent and transparent aerogel-reticulated foams and the application of these materials in translucent and transparent assemblies, such as windows, are also discussed.

### BACKGROUND

The United States consumes roughly 97 quadrillion Btus (quads) of primary energy per year, and the Nation's 87 million homes and commercial buildings consume 36% or 34.2 quads of this total. Buildings also use two-thirds of all electricity generated nationally. More than $230 billion is spent each year in the U.S. to provide heating, cooling, lighting and related energy services for buildings. Even if the energy intensity of buildings remains constant, as more buildings are constructed, energy consumption and associated economic and environmental costs will continue to escalate. Energy consumption in buildings is a major cause of acid rain, smog, and greenhouse gas emissions in the United States, representing 35% of carbon dioxide emissions, 48% of sulfur dioxide emissions, and 21% of nitrogen oxide emissions.

A large portion of energy in buildings and homes is lost through windows whose R-value is only a small fraction of those of the walls and roof. There have been steady improvements in windows over the years: currently, windows have U-values ranging from U-2.7 W/m2 K for double glazing with low E-glass to U-1 for triple glazing with all the advanced features such as spectrally-selective low E-coating, Krypton gas fill, and thermal breaks. (N.B.: U-values are typically expressed in metric units, while R-values are most often in English units. When they are expressed in equivalent units, U-value=1/R-value) Even though this is a far cry from the double-glazing windows of twenty years ago, even the best windows do not compare with insulating values for walls or roofs. Besides, the price for the lowest U-value window glazing is so high that most houses do not use triple or quadruple glazing. Even the Energy Star requirement for windows used in the Northern Zone of the USA is only U-2. However, if all the residential windows in the U.S. were replaced with the more efficient Energy Star qualifying models, $7 billion in energy costs could be saved over the next 15 years.

Superinsulating windows with U-values below 1 W/m2 K can be constructed in several ways. Most common is triple-glazed systems using coatings with low emissivity and noble gas filling of the gap between the transparent layers. By increasing the number of glass panes in the window, the U-value can be reduced even further. However, the compromise for the very low U-value will be a low transmission of solar energy and, to a lesser extent, daylight, both of which will have a negative impact on the total energy balance of the window, especially in heating dominated climates. Hutchins et al. (1997, International Energy Agency Solar Heating and Cooling Programme Task 18, Advanced Glazing Materials, Technical Reports of Subtask A and Subtask B) showed that the center U-value of an evacuated glazing with two hard low-E coatings is about 1.3 W/m2 K. It was found that the edge seal in the vacuum glazing increases the overall U-value for a 1.0×1.0 m2 glazing by about 0.3 W/m2 K. By applying more advanced coatings it may be possible to obtain overall U-values of about 1.0 W/m2 K, but again the consequence for this is a relatively low solar gain. So far it has not been possible to construct a glazing that has both a very high thermal resistance and a high transmittance of solar energy and light.

A material that has a high transparency and a high R-factor (low U-value) is needed to make super insulated windows readily available. If such a material were used to make superinsulated windows with U-values less than 1 W/m2 K, then buildings would be highly energy efficient. If such windows were widely available and used in new and existing buildings, the magnitude of energy savings would be very significant.

Aerogels, which exhibit extremely low density, high surface area, good optical, thermal, and acoustic properties, have been used previously to try to address this need and other needs for which their properties could be advantageous. However, aerogels have inherent drawbacks such as weakness and brittleness. Notably, when making highly transparent and hydrophobic aerogels, brittleness becomes much more acute, and thus they are more difficult to handle, and require long cycle times for fluid drying in order to avoid cracking.

The weakness and brittleness of low density aerogels can particularly have a negative impact on production scale-up and limit large scale manufacturing. Additionally, aerogels with lower densities may have the best transparency, but also exhibit higher thermal conductivity and thus, exhibit worse insulation performance.

The fragile structure of an aerogel (low density and high porosity) also poses several difficulties in conforming to irregular surfaces, or maintaining integrity in dynamic conditions such as when sandwiched between glass and different thermal expansion coefficients between glass and aerogel results in compressive forces. So, flexibility, compressibility, integrity, durability, strength, and resistance to sintering, dusting and cracking are all areas for potential improvement in aerogels and aerogel composites.

A further complexity has been that flexibility and translucency (or transparency) have been mutually exclusive in aerogels and aerogel composites.

A number of attempts have been made to improve aerogels and aerogel composites to address these problems and take fuller advantage of their remarkable properties as materials. Some patents describe attempts to make composites with foams and particulate aerogels, for example, EP0489319, and U.S. Pat. Nos. 6,136,216; 5,691,392; 6,040,375; and 6,068,882. Others, for example, U.S. Pat. Nos. 4,966,919; 5,037,859; 5,972,254; 5,973,015; and 6,087,407; and US Patent Application Publication No. 2002/0094426 describe other aerogel or aerogel composites with or without foams. Some, such as US Patent Application Publication No. 2005/0192367 and U.S. patent application Ser. No. 11/392,925 describe transparent aerogels or aerogel composites.

Despite these efforts problems still remain, for example excessive dusting, rigidity, inflexibility, low durability, stiffness and tendencies to readily fracture or fragment. For some composites, the thermal performance is significantly degraded as compared to aerogel monolith alone, or they have relatively low thermal stability in air under high heat loads as well as insufficient flexibility for many uses. And, for some, cracking and inflexibility also places limits on synthesis at production scale. Macro scale phase separations also make it inherently difficult to produce transparent aerogel composites with a reinforcing phase.

Thus the prior aerogel composite materials have not been suitable for many uses due to one or more of: low flexibility, low conformability, insufficient compressibility, low durability, cracking, excessive aerogel sintering when exposed to heat, less than ideal thermal conductivity, insufficient x-y thermal and/or electrical conductivity, poor RFI-EMI attenuation, and/or insufficient burn-through resistance, low production value, excessive dusting, and lack of translucency or transparency.

The present invention arose from research directed to resolving these problems. Accordingly, it is an object of the present invention to produce an improved aerogel composite structure which exhibits improvement in (or in some cases simply the presence of) one or more of the following qualities: low sintering/higher temperature performance, flexibility, conformability, compressibility, durability, low cracking, low dusting, low density, low or exceptionally low thermal conductivity, drapability, higher temperature performance, rollability, resiliency to compression during sol-gel incorporation, amenability to large-scale production, coefficient of thermal expansion (CTE), enhanced x-y thermal and/or electrical conductivity, enhanced RFI-EMI attenuation, and/or enhanced burn-through resistance, translucency or transparency, or some combination thereof.

### SUMMARY OF THE INVENTION

The Applicants have discovered that producing an aerogel-open cell foam composite wherein the open cell foam component has a pore size greater than 50 microns provides a surprisingly flexible aerogel composite with superior properties to other flexible aerogel composites, exhibiting improved flexibility combined with transparency over aerogel composites with fibrous batting such as may be found in US Patent Publication No. 20020094426. They have further discovered that producing an aerogel-open cell foam composite wherein the open cell foam component has a pore size greater than 50 microns provides a flexible translucent aerogel composite with superior properties to transparent aerogels.

In one embodiment the invention provides an improved flexible aerogel composite. In general, aerogel-open cell foam composites of the invention provide advantages as flexible materials of low thermal conductivity, light weight, and low density, and may provide the further advantage of translucency. Other important properties, at least for purposes of commercialization, include ease and flexibility of manufacture, for example, the ability to withstand the stresses that typically exist during manufacture that cause degradation (e.g., shrinkage and/or cracking), and the ability to make composites from foams having a broad range of properties, sizes and shapes that can also be made in situ. The improved compressive and flexural resilience of the gel compositions described by the invention allow for creation of larger crack free monolithic structures compared to pure silica aerogel produced under the same processing conditions. Aerogel-foam composites are also rollable, providing significant advantages in large scale production. The methods described in this invention represent advances in gel formations that will facilitate production and improved properties of these aerogel materials.

Aerogel-foam composites can maintain a high level of light transmission and have useful properties such as flexibility and strength, which provide for an improved flexible and translucent aerogel composite. The invention also provides for an improved process for producing translucent aerogel composites. Aerogel-open cell foam composites are flexible and easier to handle than typical translucent or transparent aerogels, which tend to be fragile and subject to cracking in wet gel handling and in supercritical extraction. This improvement offers a significant advantage for producing crack-free transparencies such as insulated window inserts between support members and the like.

Aerogels-foam composites are useful as thermal insulators, and as acoustic insulators, as cushioning, as well as numerous other uses described herein. Reticulated foams and open cell foams exhibit better incorporation of aerogel into the foam matrix. They are especially suited for use when low thermal conductivities, light weight, flexibility, translucency, and transparency are desired.

In one embodiment, the invention provides a flexible aerogel-open cell foam composite, comprising at least one open cell foam component and at least one aerogel matrix. In additional embodiments, this flexible aerogel-open cell foam composite may have an open cell foam component that is a flexible foam, an open cell foam component that has a pore size greater than 50 microns, an open cell foam component that is a coarse cell foam, an open cell foam component that is at least about 10% open cell foam, an open cell foam component, that is at least about 50% open cell foam, an open cell foam component that is at least about 80% open cell foam, an open cell foam component that is at least about 85% open cell foam, an open cell foam component that is a polyolefin foam, an open cell foam component that is a polyurethane foam, and an open cell foam component that is a rebond foam. In another embodiment, a flexible aerogel-open cell foam composite of the invention has an aerogel matrix based on a component selected from the group consisting of: silica, alumina, titania, zirconia, yttria, hafnia, or a combination thereof.

In embodiments a flexible aerogel-open cell foam composite of the invention has a thermal conductivity of less than about 50 mW/mK. In other embodiments, a flexible aerogel-open cell foam composite of the invention has a thermal conductivity of less than about 25 mW/mK. And in still other embodiments, a flexible aerogel-open cell foam composite of the invention has a thermal conductivity of less than about 20 mW/mK.

In embodiments a flexible aerogel-open cell foam composite of the invention has a density of less than about 0.150 g/cc. In other embodiments, a flexible aerogel-open cell foam composite of the invention has a density of less than about 0.125 g/cc. And in still other embodiments, a flexible aerogel-open cell foam composite of the invention has a density of less than about 0.120 g/cc. And in yet other embodiments, a flexible aerogel-open cell foam composite of the invention has a density of less than about 0.100 g/cc. In still other embodiments, a flexible aerogel-open cell foam composite of the invention has a density of less than about 0.110 g/cc. And in yet more embodiments, a flexible aerogel-open cell foam composite of the invention has a density of less than about 0.115 g/cc.

In embodiments of invention, a flexible aerogel-open cell foam composite transmits incident light by at least about 10% or by at least 20% or by at least 30% or by at least 50%. Such transmission rates may be tailored by the choice of aerogel precursors, fillers, foam, pore size of the foam, flexibility of the foam, processing methods or by a combination of the above.

In embodiments of invention, a flexible aerogel-open cell foam composite additionally comprises one or more fillers. In some embodiments, the largest dimension of said fillers is less than about 100 μm. Flexible aerogel-open cell foam composites comprise less than about 50% by weight metal silicate filler in embodiments of the invention. And, in embodiments of the invention, at least one metal silicate filler is a wollastonite. In another embodiment at least one filler is a microfiber.

In embodiments of the invention, a flexible aerogel-open cell foam composite may additionally comprise an Fe-containing compound dispersed within itself. In another embodiment, a flexible aerogel-open cell foam composite may additionally comprise an Mn-containing compound dispersed within itself. And in yet another embodiment, a flexible aerogel-open cell foam composite may additionally comprise an Cu-containing compound dispersed within itself.

An embodiment of the invention wherein a flexible aerogel-open cell foam composite is encapsulated is provided, as is a flexible aerogel-open cell foam composite is sealed with a sealant.

The invention is embodied in a laminate comprising a flexible aerogel-open cell foam composite, as well as in an optically translucent and thermally insulating assembly comprising at least two planer support members capable of transmitting light, positioned facing each other and spaced thereby defining a gap there between; and having at least one continuous layer of aerogel-open cell foam composite positioned within said gap and secured between said support members, and said aerogel-open cell foam composite having optical transmittance of at least about 90% in the visible spectrum. Other embodiments of these optically translucent and thermally insulating assemblies include ones wherein the aerogel-open cell foam composite does not rupture below about 16.2% flexural strain, wherein the support members comprise a glass material containing less than about 10% iron, and wherein the support members comprise a polymer selected from a group consisting of: polycarbonates, acrylics, polyethylenes, polypropylenes, cellulose acetate butyrates, glycol modified polyethylene terephthalates, polyvinyl chlorides, and a combination thereof.

The invention provides as an embodiment an optically transparent and thermally insulating assembly comprising at least two planer support members capable of transmitting light, positioned facing each other and spaced thereby defining a gap there between; and at least one continuous layer of aerogel-open cell foam composite positioned within said gap and secured between said support members. And the invention further provides for such optically transparent and thermally insulating assemblies, wherein said assembly has an optical transmission of at least about 30% in the visible spectrum.

In another embodiment, the invention provides a heated and insulated containment system with an internal volume defined by at least three walls wherein at least one of said three walls comprises at least two planer support members capable of transmitting light, positioned facing each other and spaced thereby defining a gap there between; and at least one continuous layer of aerogel-open cell foam composite positioned within said gap and secured between said support members, said aerogel-open cell foam composite having optical transmittance of at least about 90% in the visible spectrum thereby allowing solar radiation to substantially enter said internal volume.

The invention provides a method of preparing an aerogel-open cell composite material comprising the steps of (a) forming a composite gel from a mixture comprising gel precursors and an open cell foam; and (b) drying the gel. The invention also provides embodiments of this method, further comprising the step of dispensing an amount of fillers into a gel precursor solution, thereby forming said mixture; further comprising the step of mixing an amount of a filler with an amount of gel precursor in a suitable solvent; further comprising the step of dispensing the mixture comprising fillers and gel precursors, into an open cell foam; further comprising the step of dispensing the mixture comprising fillers and gel precursors, into an open cell foam wherein, said open cell foam has a pore size greater than 50 microns; further comprising the step of dispensing the mixture comprising fillers and gel precursors, into an open cell foam wherein, said open cell foam is a reticulated foam; further comprising the step of dispensing the mixture comprising fillers and gel precursors, into an open cell foam wherein, said open cell foam is a coarse cell foam; further comprising the step of dispensing the mixture comprising fillers and gel precursors, into an open cell foam wherein, said open cell foam is at least about 80% open cell foam; further comprising the step of dispensing the mixture comprising fillers and gel precursors, into an open cell foam wherein, said open cell foam is a flexible foam; further comprising the step of dispensing the mixture comprising fillers and gel precursors, into an open cell foam wherein, said open cell foam is a polyolefin foam; further comprising the step of dispensing the mixture comprising fillers and gel precursors, into an open cell foam wherein, said open cell foam is a polyurethane foam; wherein the gel precursors comprise silica, titania, zirconia, alumina, hafnia, yttria, ceria, or a combination thereof; wherein the fillers are metal silicate fillers; wherein the gel is dried with a supercritical fluid; and wherein the gel is dried with a supercritical fluid comprising CO₂.

The present invention provides methods for producing solvent filled, nanostructured gel monoliths as well as flexible blanket composite sheet materials, produced therefrom via open cell or reticulated foam reinforcement. The composite sheets result after all mobile phase solvents are extracted using a hypercritical solvent extraction (supercritical fluid drying).

### BRIEF DESCRIPTION OF THE DRAWINGS

FIG. 1 shows a method of preparing gel sheets formed from aerogel precursors and open-cell foam sheets.

### DESCRIPTION

### Definitions

The following definitions are provided to help clarify language used to understand embodiments of the invention as used throughout this specification and the appended claims, and as potentially modified by context.

“Aerogel” refers to a unique class of ultra size, low density, and primarily open-cell materials. Aerogels are a class of materials generally formed by removing a mobile interstitial solvent phase from the pores of a gel structure supported by an open-celled polymeric material at a temperature and pressure above the solvent critical point. By keeping the solvent phase above the critical pressure and temperature during the entire solvent extraction process, strong capillary forces generated by liquid evaporation from very small pores that can cause shrinkage and pore collapse are not realized. Aerogels typically have low bulk densities (about 0.15 g/cc or less, preferably about 0.03 to 0.3 g/cc), very high surface areas (generally from about 400 to 1,000 m²/g and higher, preferably about 700 to 1000 m²/g), high porosity (about 95% and greater, preferably greater than about 97%), and relatively large pore volume (more than about 3.8 mL/g, preferably about 3.9 mL/g and higher). The combination of these properties in an amorphous structure gives the lowest thermal conductivity values (9 to 16 mW/mK at 37° C. and 1 atmosphere of pressure) for any coherent solid material.

Aerogels have continuous porosity and a microstructure composed of interconnected colloidal-like particles or polymeric chains with characteristic diameters of 100 angstroms. These microstructures impart the high surface areas to aerogels. Their ultra fine cell/pore size minimizes light scattering in the visible spectrum, and thus, aerogels can be prepared as transparent, porous solids. Further, the high porosity of aerogels makes them excellent insulators with their thermal conductivity being about 100 times lower than that of the prior known fully dense matrix foams. Still further, the aerogel skeleton provides for the low sound velocities observed in aerogels.

Aerogels may be in a “wet-gel” form in which the aerogel matrix retains fluid such as a solvent phase, but more preferably aerogels are in a dried form, such as that produced by ambient pressure drying or supercritical extraction. Specifically, and as used herein, an aerogel has a dried form for which: (1) the average pore diameter is between about 2 nm and about 50 nm, which may be determined from the multipoint BJH (Barrett, Joyner and Halenda) adsorption curve of N₂ over a range of relative pressures, typically 0.01-0.99 (“the BJH method” measures the average pore diameter of those pores having diameters between 1 and 300 nm and does not account for larger pores); and (2) at least 50% of its total pore volume comprises pores having a pore diameter of between 1 and 300 nm. The size of the particles and the pores of an aerogel typically range from about 1 to about 100 nm.

Aerogels of various compositions are known, for example inorganic aerogels (such as silicon aerogels), organic aerogels (such as carbon aerogels) and inorganic/organic hybrids (see N. Hüsing and U Schubert (1998) Angew. Chem. Int. Ed. 37: 22-45). Inorganic aerogels are generally based upon metal alkoxides and include materials such as silica, carbides, and alumina. Inorganic aerogels, for example, silica, alumina, or zirconia aerogels, are traditionally made via the hydrolysis and condensation of metal alkoxides, such as tetramethoxy silane or via gelation of silicic acid or of water glass. Organic aerogels include, but are not limited to, urethane aerogels, resorcinol formaldehyde aerogels (RF), polyolefin aerogels, melamine-formaldehyde aerogels, phenol-furfural aerogels and polyimide aerogels. Most of the aerogels may be carbonized using typical processes available. Organic aerogels, such as RF aerogels, are typically made from the sol-gel polymerization of resorcinol or melamine with formaldehyde under alkaline conditions. Each type of aerogel, inorganic or organic, involves the formation of a gel, and drying of the gel by either air drying, other forms of subcritical fluid extraction, or supercritical extraction. The final composition of the aerogel is determined by the processing of the gel, which may produce a xerogel, an aerogel, or a hybrid xerogel/aerogel. Following the drying operation of the organic gels, for example, the aerogel may be pyrolyzed to produce a carbon aerogel.

Aerogels can also be classified by their bulk properties. Monolithic aerogels may be considered one class of aerogels, as opposed to beads, particles, powders, and putties. Thin film and sheet aerogels can be defined as a coating, less than 5 mm thick, formed on a substrate. Granular or powder aerogels can be defined as comprising particle sizes of having volumes less than 0.125 mL. In general, aerogels that can be made in monolithic form have advantages over thin film or granular aerogels. For example, monolithic aerogels can be made for a wide variety of applications in which thin films, sheets or granulars would not be practical. For example, most thermal insulation, acoustical attenuation and kinetic (shock absorption) applications require thicker insulating material that cannot be provided by thin films or sheets. And, granular materials tend to settle and are not mechanically stable. Many chemical and catalytic applications also require more material than can be provided by thin films or sheets. Even some electrical applications require monolithic materials such as fuel cells and large capacitor electrodes.

Low-density aerogel materials (0.01-0.3 g/cm³) are widely considered to be the best solid thermal insulators, better than the best rigid foams with thermal conductivities of 10 mW/mK and below at 100° F. and atmospheric pressure. Aerogels function as thermal insulators primarily by minimizing conduction (low density, tortuous path for heat transfer through the solid nanostructure), convection (very small pore sizes minimize convection), and radiation (IR absorbing or scattering dopants are readily dispersed throughout the aerogel matrix). Depending on the formulation, they can function well at cryogenic temperatures to 550° C. and above. Aerogel materials also display many other interesting acoustic, optical, mechanical, and chemical properties that make them abundantly useful.

As used herein, “aerogel-foam composite” may be used to generally encompass aerogel-open foam composites, aerogel-reticulated foam composites, and the like.

As used herein, “aerogel-open cell foam composite” refers to an aerogel composite material of the invention, wherein the reinforcing phase comprises an open cell foam.

As used herein, “aerogel-reticulated foam composite” refers to an aerogel composite material of the invention, and a subset of aerogel-open cell foam composites, wherein the reinforcing phase comprises a reticulated foam.

As used herein, “beads” generally refers to aerogel bodies of generally granular or particulate form having a diameter typically in the range of tenths of millimeters to about a few centimeters.

As used herein, “cell” refers to a cavity remaining in the structure of a foam surrounded by polymer membranes and/or the polymer skeleton, such as when a process of reticulation has been completed.

As used herein, “cell count” refers to the number of cells per linear inch or centimeter, expressed as pores per inch (ppi) or pores per centimeter.

As used herein, “cell opening” refers to, the breaking of membranes within the cell structure in foamed materials, permitting flow of air through the material.

As used herein, “cell size” or “cell diameter” refers to the average diameter of the average pore size cell in a foam, or the diameter of a specific cell in a foam, or the average diameter of a specified subset of cells in a foam. Average pore size, as used herein, is the average of the pore diameters of at least the 20 largest pores identified by visual examination of images generated by scanning electron microscopy (“SEM”) (preferably considered pore diameters tend to be within two orders of magnitude of the least of the 20 largest), in a field reasonably representative of the portion of the foam being considered. These pore diameters may then be measured (or reasonably approximated for pores that are not reasonably spherical), for example, with the use of ImageJ software, available from the National Institutes of Health (NIH) using average pore area and then calculating the average pore diameter by using the formula: area=πr². Average pore size may be used in measuring the pore size of a foam, such as a reticulated, closed cell, or open cell foam, or of the reinforcing phase of a composite, where the reinforcing phase can be visually distinguished. Foams and composites may require cross-sections be taken or an edge of the foam or composite be used to determine average pore size.

As used herein, “cell wall” or “cell membrane” or “cell window”, or where the context infers a “wall,” “window,” or “membrane” is of a cell refer to the thin polymer membranes formed between cell struts. Walls may be present (a closed-cell foam) or absent (an open-cell foam) depending on the particular foam chemistry used. Membranes may also be removed through a reticulation process.

As used herein, “closed cells” refers to foam cells having intact cell membranes, thereby reducing or eliminating passageways for liquid or airflow.

As used herein, “closed cell foams” are foams having closed cells and fewer open cells by percentage than an open cell foam.

As used herein, “coarse cells” refers to large foam cells, averaging 20 to 60 cells per lineal inch (ppi) or fewer.

As used herein, “coarse cell foams” refers to foams comprising coarse cells. Coarse cell foams may be “coarse closed cell foams” or “coarse open cell foams.” Coarse cell foams of the invention are preferably coarse open cell foams.

As used herein, “composite” refers to a solid material comprising aerogel material and a reinforcing phase, and at least one substance, preferably the reinforcing phase itself, that introduces flexibility into the aerogel material to make it more flexible than in the absence of the material. The aerogel material may be a continuous matrix or unitary material or a “monolithic” material as opposed to particles or beads. The composite thus retains at least one of the properties of the aerogel material and at least one of the properties of the flexibility introducing substance, respectively, though such properties may be diminished. The respective properties of the aerogel material and the flexible substance contribute to the desirable properties of a flexible aerogel. The aerogel material, flexibility introducing substance, and any other material that may be present in the composite are combined at least on a macroscopic scale. The aerogel in the solid composite may be in the form of a continuous matrix, unitary material or a “monolithic” material or discrete particles or beads. A continuous matrix refers to some degree of continuum which is beyond discrete particles or beads. A unitary or monolithic matrix refers to it being in one piece with or without additional ingredients in the structure.

As used herein, a “dispersant” refers to a component that enhances dispersion. Examples of dispersants include, but are not limited to Disperbyk 184 or 192 from BYK-Chemie, Wallingford, Conn.

As used herein, “drapable” and “drapability” refer to a material's ability to drape, and successfully meeting the criteria of a drape test, for example, draping over a person's arm, the equivalent of approximately a 2″ radius of curvature, bend of about 180°. A composite of the invention able to drape with a 2″ radius of curvature (or lower), bend of about 180° (or greater) is considered highly drapable. Preferably drapable composites of the invention are capable of bending at least 90°, at least 95°, at least 100°, at least 105°, at least 110°, at least 115°, at least 120°, at least 125°, at least 130°, at least 135°, at least 140°, at least 145°, at least 150°, at least 155°, at least 160°, at least 165°, at least 170°, or at least 180°, and/or have a bending radius of less than 4 feet, of less than 3½ feet, of less than 3 feet, of less than 2½ feet, of less than 2 feet, of less than 1½ feet, of less than 1 foot, of less than 11 inches, of less than 10 inches, of less than 9 inches, of less than 8 inches, of less than 7 inches, of less than 6 inches, of less than 5 inches, of less than 4 inches, or of less than 3 inches. Embodiments include those wherein the composite does not exhibit any substantial macroscopic failure, such as might be evidenced by fracture or cracking under such conditions. A substantial macroscopic failure is one that is visually detectable by the unaided eye, such as fractures or cracks visually detectable by the unaided eye.

As used herein, “dusting” refers to the tendency of aerogels and aerogel composites to give off dust, such as silica dust. Generally it is desirable to minimize dusting, preferably by improving the inherent integrity of the material, but possibly through other means, such as encapsulation. The dustiness may be determined or compared through an appropriate method known in the art.

As used herein, “encapsulation” refers to enclosing, at least partially, or sealing, such as with a sealant, an aerogel-open cell foam composite of the invention. Examples of suitable materials for encapsulation include woven and non-woven fabrics, but any appropriate materials may be used. Preferably the encapsulation has minimal impact on composite properties, such as transparency or thermal conductivity, and may enhance properties such as strength, flammability, durability, maintenance of transparency, easy of handling, ease of attachment, ease of conformability, or reduce dusting.

As used herein, “filler” (alternatively “dopant”) refers to one or more substances added to or as part of the process to produce an aerogel, foam, or aerogel composite. A filler is usually relatively inert, and may be added to impart at least one specific property, such as smoke suppression, HCN mitigation, special flow characteristics, improved hardness, improved stiffness, flexibility, tensile strength, resistance to sintering, or impart form, such as roundness, or reduce costs, extend volume, or increase the bulk.

As used herein, “flexible” and “flexibility” refer to a material's ability to be bent or flexed (pliable), preferably such that the material is non-rigid and may be applied and conformed to three-dimensional surfaces of objects, or pre-formed into a variety of formats to simplify installation. Preferably flexible composites of the invention are capable of bending at least 5°, at least 10°, at least 15°, at least 20°, at least 25°, at least 30°, at least 35°, at least 40°, at least 45°, at least 50°, at least 55°, at least 60°, at least 65°, at least 70°, at least 75°, at least 80°, at least 85°, and/or have a bending radius of less than 4 feet, of less than 3½ feet, of less than 3 feet, of less than 2½ feet, of less than 2 feet, of less than 1½ feet, of less than 1 foot, of less than 11 inches, of less than 10 inches, of less than 9 inches, of less than 8 inches, of less than 7 inches, of less than 6 inches, of less than 5 inches, of less than 4 inches, of less than 3 inches, of less than 2 inches, of less than 1 inch, of less than ½ inch. A material may be considered highly flexible if it is capable of bending to at least 90° and/or have a bending radius of less than ½ inch. Flexibility may be attributed in the instant invention to the foams of different kind described in the instant invention as well as the composites described in the instant invention or produced by the processes of the instant invention.

Embodiments include those wherein the composite does not exhibit any substantial macroscopic failure, such as might be evidenced by fracture or cracking under such conditions. A substantial macroscopic failure is one that is visually detectable by the unaided eye, such fractures or cracks visually detectable by the unaided eye.

As used herein, a “foam” is a solid formed by a dispersion in which a large proportion of gas by volume in the form of gas bubbles, is dispersed in a liquid, solid or gel and that may have been stabilized by solid particles or by soluble substances. In general, foams can be made using a wide variety of processes—see, for example, U.S. Pat. Nos. 6,147,134; 5,889,071; 6,187,831; and 5,229,429.

Foams may be open-cell foams or closed-cell foams. In closed-cell foams each cell (often more or less spherical in shape) is completely enclosed by a thin wall or membrane, whereas in open-cell foams the individual cells are interconnected. “Expanded plastic” can be used to refer to closed-cell materials; “sponge” is sometimes used for open-cell foams (e.g., “sponge rubber”). A foam of the invention will generally have a density less than 100 g/cc, preferably less than 10 g/cc, less than 5 g/cc, less than 1 g/cc, more preferably less than 0.5 g/cc, less than 0.2 g/cc, less than 0.1 g/cc, less than 0.08 g/cc, or less than 0.05 g/cc.

With respect to the base resin of a matrix, plastic foams may be either thermoplastic or thermosetting. Thermoplastic foams are based on linear polymers exhibiting a definite melting range normally associated with the base resin in the matrix. In contrast, thermosetting foams based on cross-linked polymers do not normally exhibit a definite melting range, although they may show some limited plastic flow at elevated temperature. Typical thermoplastic foams are polystyrene, poly(vinyl chloride) (PVC), the polyolefins (polyethylene and polypropylene) and ABS foams. Common thermoset foams include polyurethane (also called urethane), phenol-formaldehyde (phenolic), urea-formaldehyde and epoxy foams.

Cell structure may determine certain properties, thereby influencing the type of application of foamed plastics. Open-cell foams tend to offer little resistance to the passage of liquids and gases through them. A general principle is that flexible foams tend to have open-cell structure and rigid foams tend to have closed cells. The cell structure depends on the process used for the production of the foamed plastic; in some cases both flexible and rigid foams may be produced with either open or closed cells (e.g., PVC; a further example is the rigid open-cell foams of U.S. Pat. No. 4,454,248). Generally, no foam has entirely one type of cell structure (open- or closed-cell structure implies that the number of cells in the foam is predominantly open or closed, respectively). For example, most rigid polyurethane foams have high closed-cell contents, usually 85 to 95 percent for a 2-lb/ft³ foam.

As used herein, a “hybrid aerogel” is an aerogel produced from a mixture or combination of two or more gel precursors.

As used herein, “hybrid foams” may be used to refer to foams that are organic/inorganic and/or foams that are thermoplastic/thermoset hybrids.

As used herein, “open cell foams” refers to foams having an open cell structure, or that are rendered open cell through the methods of the invention (e.g., the cell membranes are chemically ruptured (cell opening) as part of the process of incorporating the sol-gel into the foam). Open cell foams that have an open cell structure prior to use in the methods of the invention may be referred to as “initially open cell foams.” Open cell foams may be formed directly or from a closed cell foam, or from an open cell foam with a lesser percentage of open cells, through reticulation (they may be reticulated foams). Open cell foams may also be formed by rebonding, and be “rebonded open cell foams.” Open cell foams of the invention preferably exclude aerogels. Open cell foams of the invention may or may not have fillers. Open cell foams of the invention may be have cells of any appropriate geometry, such as dodecahedron, roughly spherical, and the like. And, the open cell foams of the invention may be thermoplastic, thermosetting, or thermoplastic/thermoset hybrids (e.g., see U.S. Pat. No. 6,323,251). Open cell foams of the invention may be at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 97%, at least 99%, or 100% open cell. Preferably the reticulated foams of the invention are polyolefin foams, and more preferably they are polyurethane foams, though organic, inorganic, and or hybrid foams are all suitable for the invention. Open cell foams may more easily incorporate materials into their matrix through freeflow than other materials, such as closed cell foams, and may also be more amenable to passage of light.

As used herein, an “open cell foam component” refers to the open cell foam and the properties thereof used in the methods of the invention to produce an aerogel-open cell foam composite of the invention.

As used herein, “open cell structure” refers to a permeable structure in foam in which most cell walls (also called membranes or windows) have been ruptured to varying extent and gases or liquids can pass through the foam.

As used herein, “ppi” stands for “pores per inch.”

As used herein, “precursor” or “gel precursor” refers to a material used in the, possibly catalyzed, hydrolysis reaction of a sol-gel process as may be used to potentially produce a sol and eventually an aerogel. Such materials are often called “polymeric precursors” or “preceramic polymers.”

As used herein, a “rebonded foam” is a foam that results from a process of adhering small particles of foam (often manufacturing scrap) together. Various adhesives and bonding processes may be used, and the foam used may be ground or shredded prior to rebonding. Foam may be rebonded as a way to lower cost through the use of foam that would otherwise be waste. A typical application for rebonded foam is as carpet underlay. It should be noted that the aerogels of the invention are not aerogel particles or powders that have been adhered together with a binder or compacted, for example by the methods of U.S. Pat. No. 6,620,355.

As used herein, a “rebonded reticulated foam” is a rebonded foam formed at least in part from reticulated foam or reticulated foam particles. More specifically “rebonded foam reticulates” may be used to refer to just those portions of the rebonded foam made up of reticulated foam or reticulated foam particles.

As used herein, “reinforcing phase” refers to a component of composites of the invention, which consists primarily of a foam material, preferably an open cell foam material, and more preferably a reticulated foam material.

As used herein, “resiliency” refers to the ability of the material to return to original form or dimension of a material following compression or flexing (bending) depending on the context. Resiliency may be complete or partial and it may be expressed in terms of percentage return. Resiliency may be attributed in the instant invention to the foams of different kind described in the instant invention as well as the composites they produce through the processes of the instant invention.

As used herein, a “reticulated foam” is a flexible foam characterized by a three-dimensional skeletal structure and an open cell structure with few or no membranes between strands (struts). Reticulated foams of the invention are produced through a process of reticulation to eliminate or puncture cell membranes, for example, through, chemical methods, such as alkali reticulation (see U.S. Pat. No. 3,862,282, or U.S. Pat. No. 3,125,542, for example, or see U.S. Pat. No. 3,405,216, U.S. Pat. No. 3,171,820, or Belgian Patent No. 543,362 for other examples of chemical methods); thermal methods, such as thermal reticulation (see U.S. Pat. No. 3,862,282); mechanical methods, such as physical crushing or puncturing, explosion processes, such as are described in U.S. Pat. No. 3,175,025; 3,390,106; 3,297,803; or 3,456,047, or hydrodynamic reticulation (see U.S. Pat. No. 3,862,282); other methods known in the art (e.g., U.S. Pat. No. 3,175,030 or 3,329,759); and combinations thereof (e.g., U.S. Pat. No. 2,961,710 describes a reticulation process which involves soaking foam in a weakening agent, coupled with violent agitation, for a chemical and mechanical combination). Reticulated foams of the invention may be at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 97%, at least 99%, or 100% open cell. Preferably the reticulated foams of the invention are polyolefin reticulated foams, and more preferably they are polyurethane reticulated foams, though organic, inorganic, and or hybrid foams are all suitable for the invention. Some non-limiting examples of reticulated foams may be found in U.S. Pat. Nos. 6,841,586; 6,756,416; 6,596,785; 6,371,606; 6,136,870; 5,567,740; and 5,034,422. Typically reticulated foams are polyurethane foams or polyolefin foams. Reticulated foams are generally used as filters, acoustical panels, and for controlled liquid delivery. Reticulated cell foams may more easily incorporate materials into their matrix through freeflow than other materials, such as closed cell foams, and may also be more amenable to passage of light. Reticulated foam can be produced in a range of controlled pore sizes, typically from 4 through 100 pores per inch, with exemplary void volumes of up to 98% and surface areas up to 200 ft·² per cubic foot. Reticulated polyurethane foams tend to be chemical resistant, high tensile strength, and high elongation and tear properties, as well as being impervious (non-nutrient) to microbial organisms.

As used herein, “rollability” and “rollable” refer to the capability of an aerogel or aerogel composite produced in a continuous sheet form of being rolled, unrolled, and re-rolled, for example around a spindle or mandrel of appropriate radius given the material's flexibility, without significant degradation of properties of interest (e.g., thermal conductivity), so as to permit ease of transport, storage, etc. Rollability provides for more economical production of aerogels and aerogel composites. Gels that are not rollable may produced, processed, and transported as planar sheets.

As used herein, “shrinkage” refers to the ratio of the measured final density of the dried samples to the target density calculated from solid content in the sol by the following simple equation:

$$Shrinkage Factor ( f ) = \frac{Final Density ( g / {cm}_{3} )}{Target Density ( g / {cm}_{3} )}$$

Shrinkage of the composites of the invention is preferably less than 50%, less than 25%, less than 10%, less than 8%, less than 6%, more preferably less than 5%, less than 4%, less than 3%, less than 2%, less than 1%, and most preferably 0%.

As used herein “solvent” generally refers to the liquid dispersion medium used to form the wet-gels and that is removed to form aerogels in accordance with this invention.

As used herein, “thermal conductivity” may be determined by methods known in the art, for example, by a Test Method for Steady-State Thermal Transmission Properties by Means of the Heat Flow Meter Apparatus (ASTM C 518; ASTM International, West Conshohocken, Pa.), a Test Method for Steady-State Heat Flux Measurements and Thermal Transmission Properties by Means of the Guarded-Hot-Plate Apparatus (ASTM C 177; ASTM International, West Conshohocken, Pa.), a Test Method for Steady-State Heat Transfer Properties of Pipe Insulation (ASTM 335; ASTM International, West Conshohocken, Pa.), or a Thin Heater Thermal Conductivity Test (ASTM C 1114; ASTM International, West Conshohocken, Pa.).

As used herein, “translucent” or “translucency” refers to translucent or transparent materials, generally with regard to the visible light spectrum (“optically transparent”), though, on occasion, such as where defined through context, the term may be used to more broadly encompass additional wavelengths or parts of the electromagnetic spectrum. For a given thickness (generally about ¼ inch, but any thickness may be used), an aerogel-foam composite is considered transparent if it possesses the ability to transmit rays of light in such a way as to allow the human eye to see through to an object behind. For the normal human eye, a minimal measure of transmissivity is sufficient to give transparency. For example, a 1% transmissivity is sufficient to allow a human to see through a membrane while 100% transmissivity is complete transparent. With careful, inspection, a human can see through a membrane with any transmissivity over 0%. Transmissivity may be determined by any art appropriate method, including, but not limited to simple visual inspection or use of a transmissivity meter. One method for measuring transmissivity is (ASTM D1003; ASTM International, West Conshohocken, Pa.) Preferably aerogel-foam composites of the invention have a transmissivity greater than 0%, greater than 5%, greater than 10%, greater than 15%, greater than 20%, greater than 25%, more preferably of moderate transparency—greater than 30% transmissivity, greater than 35%, greater than 40%, greater than 45%, greater than 50%, greater than 55%, greater than 60%, greater than 65%, more preferably of high transparency—greater than 70% transmissivity, greater than 75%, greater than 80%, more preferably of very high transparency—greater than 85% transmissivity, greater than 90%, greater than 95%, and most preferably of extremely high transparency—greater than 96% transmissivity, greater than 97%, greater than 98%, greater than 99%, or even 100% transmissivity.

### EMBODIMENTS

The aerogel composite material of the present invention comprises two primary phases. The first is a low-density aerogel matrix and the second is a reinforcing phase. This reinforcing phase consists primarily of a foam material, preferably an open cell foam material, and more preferably a reticulated foam material. In other embodiments, either or both of these phases may further comprise additional materials such as fillers.

### Aerogel Matrix

The aerogel matrix of the present invention may be organic, inorganic, or a mixture or hybrid thereof. The wet-gels used to prepare the aerogels may be prepared by any of the gel-forming techniques that are well-known to those trained in the art: examples include adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3). Further examples of methods of aerogel production are given below following the descriptions of suitable materials for use as gel precursors. Precursors for aerogels of the composites of the invention are preferably those tending to yield highly transparent aerogels, see for examples US Patent Application Publication Nos. 2005/0192366 and 2006/0035054.

Inorganic Aerogels

Suitable materials for forming inorganic aerogels include, but are not limited to, non-refractory metal alkoxides based on oxide-forming metals. Preferred such metals are silicon and magnesium as well as mixtures thereof. The most suitable metal alkoxides are those having about 1 to 6 carbon atoms, preferably from 1-4 carbon atoms, in each alkyl group. Specific examples of such compounds include, but are not limited to alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, aluminum isopropoxide, aluminum sec-butoxide, cerium isopropoxide, hafnium tert-butoxide, magnesium aluminum isopropoxide, yttrium isopropoxide, titanium isopropoxide, zirconium isopropoxide, and the like. Mixtures of non-refractory metals with refractory metals, such as silicon and/or magnesium with aluminum, may also be used. An advantage of using more than one metal oxide matrix material for the aerogel structure is an enhancement of IR opacification, achieved by providing chemical functional groups that absorb radiation at a wider range of wavelengths. For higher temperature applications, suitable alkoxides are generally refractory metal alkoxides that will form oxides, e.g. such as zirconium alkoxides, yttrium alkoxides, hafnium alkoxides, aluminum alkoxides, titanium alkoxides, cerium alkoxides, and the like, as well as mixtures thereof, such as a mixture of zirconium alkoxides and yttrium alkoxides. In the case of silica precursors, these materials can be partially hydrolyzed and stabilized at low pH as polymers of polysilicic acid esters such as polydiethoxysiloxane (PDEOS). Pre-polymerized silica precursors in alcohol solution are especially preferred for the aerogel composite articles of this invention. Particularly preferred are gels formed primarily from alcohol solutions of hydrolyzed silicate esters due to their ready availability and low cost (alcogel).

Organic Aerogels

It is also well known to those trained in the art that organic aerogels can be made based on compounds such as, but are not limited to, urethanes, resorcinol formaldehydes, polyimides, polyacrylates, chitosan, polymethyl methacrylate, members of the acrylate family of oligomers, trialkoxysilylterminated polydimethylsiloxane, polyoxyalkylene, polyurethane, polybutadiane, a member of the polyether family of materials, polystyrenes, polyacrylonitriles, polyfurfural alcohol, phenol furfuryl alcohol, melamine formaldehydes, cresol formaldehyde, phenol formaldehyde, polyvinyl alcohol dialdehyde, polycyanurates, polyacrylamides, various epoxies, agar, agarose, and the like, or combinations thereof (see, for example, C. S. Ashley, C. J. Brinker and D. M. Smith (2001) Journal of Non-Crystalline Solids, volume 285).

Ormosils and Organic-Inorganic Hybrid Aerogels

Organic/inorganic hybrid aerogels are mainly ormosil (organically modified silica) aerogels. Typically ormosils are formed through the hydrolysis and condensation of organically modified silanes, R—Si(OX)₃, with traditional alkoxide precursors, Y(OX)₄, where X may represent, for example, CH₃, C₂H₅, C₃H₇, C₄H₉ and Y may represent, for example, Si, Ti, Zr, or Al. R may be any organic fragment such as methyl, ethyl, propyl, butyl, isopropyl, methacrylate, acrylate, vinyl, epoxide, and the like. The organic components in this embodiment may also be dispersed throughout or chemically bonded to the silica network. As used herein, the term “ormosil” encompasses the foregoing materials as well as other organically modified ceramics, sometimes referred to as “ormocers.” Ormosils are often used as coatings where an ormosil film is cast over a substrate material through, for example, the sol-gel process. Examples of other organic-inorganic hybrid aerogels of the invention include, but are not limited to, silica-PMMA, silica-chitosan, and possible combinations of the aforementioned organic and inorganic aerogel forming compounds. Published US patent applications 2005/0192367 and 2005/0192366 teach extensively of such hybrid organic-inorganic materials and are hereby incorporated by reference in their entirety.

### Reinforcing Phase

The reinforcing material used in the present invention is one or more layers of an open cell foam. Open cell foam reinforcement preferably minimizes the volume of unsupported aerogel while avoiding substantial degradation of the thermal performance of the aerogel. Suitable foams for the reinforcing phase include, but are not limited to foams made from polymeric materials. The open cell foam is preferably in a form permitting utilization as layers or sheets. Examples include foams made from polyolefins, polyurethanes, phenolics, cellulose acetate, and polystyrene (e.g., for descriptions see Plastic Foams, Vol. II, Benning, John Wiley & Sons, 1969). Polyolefin foams are preferred. More preferred are polyurethane foams. Especially preferred is a translucent or transparent foam, for example, translucent or transparent Scottfoam® from Rogers Foam Corporation, Somerville, Mass. The following patents disclose various examples polyurethane and polyepoxide foams: U.S. Pat. No. 2,117,605; U.S. Pat. No. 3,094,433; U.S. Pat. No. 2,739,134; U.S. Pat. No. 3,112,524; U.S. Pat. No. 2,789,095; U.S. Pat. No. 3,129,191; U.S. Pat. No. 2,811,499; U.S. Pat. No. 3,171,820; U.S. Pat. No. 2,831,820; U.S. Pat. No. 2,920,983; U.S. Pat. No. 3,342,922; U.S. Pat. No. 2,926,390; U.S. Pat. No. 3,386,877; U.S. Pat. No. 2,936,294; U.S. Pat. No. 3,459,274; U.S. Pat. No. 2,993,869; U.S. Pat. No. 3,504,064; U.S. Pat. No. 3,025,200; U.S. Pat. No. 3,506,600; U.S. Pat. No. 3,055,360; U.S. Pat. No. 3,650,993; U.S. Pat. No. 3,057,750; U.S. Pat. No. 3,860,537; U.S. Pat. No. 3,060,137; U.S. Pat. No. 4,252,517; U.S. Pat. No. 3,075,926; Sweden 180,206; U.S. Pat. No. 3,082,611; France Patent No. 1,287,637; and U.S. Pat. No. 3,090,094.

The reinforcing phase of the invention is preferably a flexible, reticulated foam, a particularly polyolefin foam and polyurethane foam. Such foam is widely used for filtration and dust removal, but not for structural reinforcement of composite materials, and is a departure from the materials currently in use for aerogel reinforcement, e.g. fibrous, non-woven battings, and provides advantages in the ability of foam void sizes to engineered and static when formed. The foam should have a pore size of at least greater than 50 microns, preferably the foam is a 100 ppi foam or of greater pore size, a 95 ppi foam or of greater pore size, a 90 ppi foam or of greater pore size, an 85 ppi foam or of greater pore size, an 80 ppi foam or of greater pore size, a 75 ppi foam or of greater pore size, a 70 ppi foam or of greater pore size, a 65 ppi foam or of greater pore size, a 60 ppi foam or of greater pore size, a 55 ppi foam or of greater pore size, a 50 ppi foam or of greater pore size, a 45 ppi foam or of greater pore size, a 40 ppi foam or of greater pore size, a 35 ppi foam or of greater pore size, a 30 ppi foam or of greater pore size, a 25 ppi foam or of greater pore size, a 20 ppi foam or of greater pore size, a 15 ppi foam or of greater pore size, or a 10 ppi foam or of greater pore size.

### Fillers—Microfibers

While the composite produced may be flexible, durable, have a low thermal conductivity and a good resistance to sintering, the performance of the aerogel-open cell foam composite may be substantially enhanced by incorporating randomly distributed microfibers into the composite, particularly microfibers that will help resist sintering while increasing durability and decreasing dusting. Microfibers may reduce the rate of shrinkage and/or sintering, and the ultimate failure of an aerogel-open cell foam composite structure may be delayed by one or more orders of magnitude, i.e. increasing burn-through time from seconds to hours.

The effect of short fiber reinforcement (microfiber) on the performance of a composite will depend on a number of variables, such as fiber alignment, diameter, length, aspect ratio (fiber length/fiber diameter), strength, modulus, strain to failure, coefficient of thermal expansion, and the strength of the interface between the fiber and the matrix. The microfibers are generally incorporated into the composite by dispersing them in the gel precursor liquid and then using that liquid to infiltrate the foam. Preferably microfibers minimally impact or improve flexibility, translucency, or both.

Suitable microfibers useful herein typically range from 0.1 to 100 μm in diameter, have high aspect ratios (L/d>5, preferably L/d>100), and are relatively uniformly distributed throughout the composite. Since higher aspect ratios can improve composite performance, the longest microfibers possible are desired. However, the length of the fibers used herein is constrained to avoid (or at least minimize) any filtration by the open cell foam when a microfiber-containing gel precursor is infused into the foam. The microfibers should be short enough to minimize filtration by the foam and long enough to have the maximum possible effect on the thermal and mechanical performance of the resulting composite. As such, the microfiber fillers described herein are distinct from the matrix in which they are embedded. The microfibers preferably have a thermal conductivity of 200 mW/mK or less to facilitate the formation of low thermal conductivity aerogel composites.

When the microfibers are dispersed in a sol, they often will rapidly settle. To overcome this problem, a suspension or dispersion agent that will not deleteriously effect the gel formation may be added to the sol. Suitable suspension/dispersion agents include solutions of high molecular weight block copolymers with pigment affinic groups (e.g., Disperbyk-184 or 192 from BYK-Chemie, Wallingford, Conn.), and the like. The agents need to be effective during at least the period of time between the dispersion of the microfiber in the gel precursor and the gelation of the sol.

The quantity, type, and/or size and aspect ratio of the microfibers used within a specific aerogel composite may be varied to meet specific tasks. For example, an application may involve insulating regions of different temperatures using a continuous aerogel composite; the composite may be made such that more microfibers will be present in the areas of the composite that will contact the higher temperature regions. Similarly, different microfibers (e.g. different material, different aspect ratio, and/or size) may be incorporated in such areas for best insulation performance. Such microfiber modification may be accomplished by using a variety of suspension agents and/or microfibers to cause the microfibers to settle into the composite at different rates and thus in different locations.

Suitable fibrous materials for the microfibers include any fiber-forming material. Particularly suitable materials include: fiberglass, quartz, polyester (PET), polyethylene, polypropylene, polybenzimidazole (PBI), polyphenylenebenzo-bisoxasole (PBO), polyetherether ketone (PEEK), polyarylate, polyacrylate, polytetrafluoroethylene (PTFE), poly-metaphenylene diamine (Nomex), poly-paraphenylene terephthalamide (Kevlar), ultra high molecular weight polyethylene (UHMWPE) (e.g. Spectra™), novoloid resins (Kynol), polyacrylonitrile (PAN), PAN/carbon, and carbon fibers. A combination of different fibrous materials may also be utilized.

Microfiber reinforcement may be useful in enhancing sintering resistance and/or reducing dusting. This may be accomplished by incorporating microfibers of a suitable material, e.g. carbon filaments, within the gel precursor (generally in combination with a suitable non-reactive dispersing agent) prior to pouring the gel precursor onto the open cell foam. When dispersed in a silica matrix, carbon microfibers provide a combination of IR opacification and microscale strengthening that give a non-refractory metal oxide such as silica greatly improved thermal and mechanical performance at higher temperatures relative to non-strengthened and opacified silica.

Fillers—Microfibers that are Metal Silicates

In one embodiment the microfibers of the present invention are metal silicate fibers. Composites of the present invention may comprise metal silicate fillers to facilitate smoke reduction (see for example U.S. Patent Application Ser. No. 60/803,189).

Metal silicate fillers of the present invention comprise at least one alkali earth metal silicate such as a beryllium silicate, a magnesium silicate, a calcium silicate, a strontium silicate, a barium silicate or a radium silicate. Preferably, the filler comprises a calcium silicate. Fillers may further comprise other non-alkali earth metals such as aluminum, iron, titanium, manganese, potassium and sodium in addition to the alkali earth metals. It is to be noted that some water-based gel preparation techniques utilize metal (e.g. sodium) silicates, but only as a silica source, leading to a final dried gel which does not per se contain metal silicate fibers.

A general formula for representing the metal silicates of the invention is: (Q)ₓ(M)_{y}SiO₃, where
M=an alkali earth metal (beryllium, magnesium, calcium, strontium, barium or radium)
Q=a non-alkali earth metal (aluminum, iron, titanium, manganese, potassium or sodium)
y=the number of different alkali earth metals and is ≧1 (i.e. 1, 2, 3, . . . )
x=the number of different non-alkali earth metals, and is ≧0 (i.e. 0, 1, 2, . . . )

Metal silicate fibers may be in mineral form, or ground, crushed, machined, or milled, such as may be performed, for example, to alter the aspect ratio or grade. Separations may be performed to alter the percentages of or remove components from a mineral form. As with other fillers, the metal silicate fibers may include or be treated with coupling agents or surface modifiers to enhance their performance in the composite matrix. In mineral form, the metal silicate fillers may be structurally grouped into Nesosilicates, Sorosilicates, Inosilicates, Cyclosilicates, Phyllosilicates, or Tectosilicates, with or without associated oxide or hydrated oxide (e.g., calcite) structures, and mixed mineral forms of one or more of the groups. Single chain Inosilicates, especially when comprising calcium, are particularly preferred although other metal silicates discussed herein are viable alternatives. Most preferred is a microfiber filler comprising wollastonite (CaSiO₃, calcium metasilicate), for example, Nyad®5000 (2.2×7 micron, Nyco Minerals, Willsboro, N.Y.).

Metal silicate fibers suitable for use are preferably such that their largest dimensions are less than about 100 μm, less than about 50 μm, less than about 10 μm, or less than about 5 μm. If substantially spherical, the “largest dimension” of a filler particle refers to its diameter whereas if rod or cone-shaped, a particles length is referenced. Alternatively, dimensions of the silicate fillers are such that the fillers readily disperse in a sol solution, or readily disperse with the aid of a dispersion agent (e.g., Disperbyk 184 from BYK-Chemie, Wallingford, Conn.) and do not prevent gel formation therein. Preferably, the aerogel composites of the present invention comprise less than about 50%, less than about 30%, less than about 20%, less than about 10%, or less than about 5% by weight of metal silicate fillers.

Metal silicate fillers may also be used as a filler to enhance smoke suppression as measured by the Smoke Density Index (SDI) estimated according to ASTM E84 (Standard Test Method for Surface Burning Characteristics of Building Materials, ASTM International, West Conshohocken, Pa.) (see U.S. Patent Application Ser. No. 60/803,189).

Fillers—Metal Hydroxides

Metal hydroxides may be used as fillers, and may be used for properties including, but not limited to, reinforcement, smoke suppression, flame suppression, and fire retardation. Metal hydroxides include, but are not limited to, hydrated aluminum oxides, magnesium hydroxide, calcium hydroxide, strontium hydroxide, and barium hydroxide.

Fillers—Main Group Oxides

Main group oxides may be used as fillers, and may be used for properties including, but not limited to, reinforcement, and pigmentation. Main group oxides include, but are not limited to, tin oxides, antimony oxides, tellurium oxides, aluminum oxides (e.g., gamma, alpha, and beta) and selenium oxide.

Fillers—Alkaline Earth Metal Oxides

Alkaline earth metal oxides may be used as fillers, and may be used for properties including, but not limited to, reinforcement, low dielectric constant, and UV shielding. Alkaline earth metal oxides include, but are not limited to, magnesium oxide, calcium oxide, strontium oxide, barium oxide, Group III metal oxides (e.g., scandium oxide, yttrium oxide, or lanthanum oxide), and zinc oxide.

Fillers—Transition Metal Oxides

Transition metal oxides may be used as fillers, and may be used for properties including, but not limited to, reinforcement, dielectrical properties, and pigmentation. Transition metal oxides include, but are not limited to, iron oxides, ruthenium oxides, osmium oxides, titanium oxides, zirconium oxides, hafnium oxides, vanadium oxides, niobium oxides, tantalum oxides, copper oxides, silver oxides, nickel oxides, palladium oxides, platinum oxides, manganese oxides, rhenium oxides, chromium oxides, molybdenum oxides, tungsten oxides including mixed phosphorus oxides (tungstic acids), and mixed oxides (e.g., lanthanum oxides, scandium oxides, and manganate oxides).

Fillers—Metal Carbonates

Metal carbonates may be used as fillers, and may be used for properties including, but not limited to, reinforcement, pH adjustment, and providing a reducing atmosphere. Metal carbonates include, but are not limited to, calcium carbonate, sodium carbonate, sodium bicarbonate, copper carbonate, and iron carbonate.

Fillers—Alkaline Earth Metal Phosphates

Alkaline earth metal phosphates may be used as fillers, and may be used for properties including, but not limited to, reinforcement, pH adjustment, smoke suppression, flame suppression, fire retardation, and to provide a reducing atmosphere. Alkaline earth metal phosphates include, but are not limited to, calcium phosphate, magnesium phosphate, aluminum phosphate, and barium phosphate.

Fillers—Alkaline Earth Metal Sulphates

Alkaline earth metal sulphates may be used as fillers, and may be used for properties including, but not limited to, reinforcement, and vibrational energy absorption. Alkaline earth metal sulphates include, but are not limited to, calcium sulphate, magnesium sulphate, and barium sulphate.

Fillers—Carbon Allotropes

Carbon allotropes may be used as fillers, and may be used for properties including, but not limited to, reinforcement, and pigmentation. Carbon allotropes include, but are not limited to, nanotubes, graphite, chaoite (carbynes), diamond, londaleite, fullerenes (e.g., C24, C28, C32, C70, etc.), buckminsterfullerenes (e.g. C60), pyrolytic carbon, carbon black and lamp black.

Fillers—Metal Carbides

Metal carbides may be used as fillers, and may be used for properties including, but not limited to, reinforcement, chemical resistance, and chemical stability. Metal carbides include, but are not limited to, silicon carbide, boron carbide, calcium carbide, iron carbide, manganese carbide, titanium carbide, vanadium carbide, aluminum carbide and tungsten carbide.

Fillers—Metal Oxycarbides and Mixed Oxides/Carbides

Metal oxycarbides and mixed oxides/carbides may be used as fillers, and may be used for properties including, but not limited to, reinforcement. Metal oxycarbides and mixed oxides/carbides include, but are not limited to, silicon oxycarbide, chromium oxycarbide, molybdenum oxycarbide, and tungsten oxycarbide.

Fillers—Lanthanide Oxides

Lanthanide oxides may be used as fillers, and may be used for properties including, but not limited to, reinforcement, and magnetic properties. Lanthanide oxides is understood to include oxides of one or more of the rare earth elements of the lanthanide series according to the Periodic Table of Elements, which includes elements 57-71.

Fillers—Organic Polymers

Organic polymers may be used as fillers, and may be used for properties including, but not limited to, reinforcement. Organic polymers include, but are not limited to, polymethyl methacrylate.

Fillers—Clays and Gums

Clays and gums may be used as fillers, and may be used for properties including, but not limited to, reinforcement, thickening, and elasticity. Clays include, but are not limited to, ball clay, bentonite, common clay, fire clay, fuller's earth, and kaolin. And, gums include, but are not limited to, guar gum, gum arabic, locust bean gum, xanthan gum, carrageenan, acacia gum, tragacanth gum, quince seed gum, and pectin.

Fillers—Transition Metal Sulfides and Selenides

Transition metal sulfides and selenides may be used as fillers, and may be used for properties including, but not limited to, reinforcement, magnetic properties, and electrical conductivity. Transition metal sulfides and selenides include, but are not limited to, iron sulfide, cobalt sulfide, copper sulfide, nickel sulfide, cesium sulfide, molybdenum sulfide, iron selenide, cobalt selenide, copper selenide, nickel selenide, cesium selenide, and molybdenum selenide.

Fillers—Spinels

Spinels may be used as fillers, and may be used for properties including, but not limited to, reinforcement, magnetic properties, and electrical conductivity. Spinels include, but are not limited to, iron oxide spinels, manganese spinels, copper spinels, cobalt spinels, rhodium spinels, and iridium spinels.

Fillers—Ceramics

Ceramics may be used as fillers, and may be used for properties including, but not limited to, reinforcement, magnetic properties, and electrical conductivity. Ceramics include, but are not limited to, aluminosilicates (e.g., mullite), calcium aluminosilicates, and zeolites.

Fillers—IR Absorbing or Reflective Pigments

IR absorbing or reflective pigments may be used as fillers, and may be used for properties including, but not limited to, reinforcement, IR absorption, and IR reflection. IR absorbing or reflective pigments include, but are not limited to, carbon black, iron oxide black, and copper chromite black.

Fillers—Opacifiers

For optimal thermal insulation, aerogels can be opacified to reduce the radiative component of heat transfer. At any point prior to gel formation, opacifying compounds may be dispersed into the mixture comprising gel precursors, preferably with a dispersant, such as Disperbyk 184 from BYK-Chemie, Wallingford, Conn. or the like, to improve thermal performance at higher temperatures by increasing the opacity of the article to IR transmission. Examples of opacifying compounds include and are not limited to: B₄C, diatomite, manganese oxides, MnO, manganese dioxide, manganese ferrite, NiO, SnO, Ag₂O, Bi₂O₃, TiC, WC, carbon black, titania, titanium oxide, iron titanium oxide, zirconium silicate, zirconium oxide, iron oxides, iron (I) oxide, iron (III) oxide, iron titanium oxide (ilmenite), chromium oxide, molybdenum silicide, silicon carbide, polydialkylsiloxanes wherein the alkyl groups contain 1 to 4 carbon atoms, and mixtures thereof. Transparency can also be decreased by introducing opacifying agents such as carbon black, graphite, titania and zirconia, in the synthetic stages, however opacifiers that minimally impact or improve translucency are preferred. Suitable amounts of opacifiers generally range from about 1 to 20% by weight of the finished composite, preferably about 2 to 10%.

Fillers—Additional IR and UV Absorption Fillers Additional fillers for IR and/or UV absorption may be found in US Patent Publication No. 20050165148, (e.g., neodymium boride or tungsten boride).

Fillers —HCN Mitigation

To reducing hydrogen cyanide (HCN) concentration during flame exposure or combustion of a nitrogen-containing carbon fiber material in an aerogel-foam composite, an Fe-, Mn-, or Cu-containing compound may be dispersed within said aerogel-open cell foam composite (see, for example, U.S. patent application Ser. No. 11/384,035).

### Aerogel Production

The following examples involve sol-gel processes of preparing gel materials wherein drying of wet-gels derived from this process yields aerogels. A sol-gel process is described in detail in Brinker C. J., and Scherer G. W., Sol-Gel Science; New York: Academic Press, 1990; hereby incorporated by reference.

Generally the principal synthetic route for the formation of an inorganic aerogel is the hydrolysis and condensation of an appropriate metal alkoxide. For the sake of convenience the alcogel route of forming inorganic aerogels is used below to illustrate the invention, though this is not intended to limit the present invention to any specific type of aerogel and/or method of preparation. The invention is applicable to other aerogels and preparation methods (e.g., direct synthesis in supercritical CO₂ (see Sui et al. Langmuir (2006) 22: 4390-4396, for example)).

Major variables in the inorganic aerogel formation process include the type of alkoxide, solution pH, and alkoxide/alcohol/water ratio. Control of the variables can permit control of the growth and aggregation of the matrix species throughout the transition from the “sol” state to the “gel” state. While properties of the resulting aerogels are strongly affected by the pH of the precursor solution and the molar ratio of the reactants, any pH and any molar ratio that permits the formation of gels may be used in the present invention.

Gel Solvents

The preparation of aerogel-forming solutions is well known in the art—see, for example, S. J. Teichner et al. (1976) Inorganic Oxide Aerogel, Advances in Colloid and Interface Science 5: 245-273, and L. D. LeMay, et al. (1990) Low-Density Microcellular Materials, MRS Bulletin, 15: 19. Generally, the solvent will be a lower alcohol, i.e. an alcohol having 1 to 6 carbon atoms, preferably 2 to 4, although other solvents can be used as is known in the art. Ethanol, is typically most preferred. Examples of other useful solvents include but are not limited to: ethyl acetate, ethyl acetoacetate, acetone, dichloromethane, tetrahydrofuran, and the like. After formation of an alkoxide-alcohol solution, water is added to cause hydrolysis so that a metal hydroxide in a “sol” state is present. The hydrolysis reaction, using tetra-ethoxysilane as an example, is:

Si(OC₂H₅)₄+4H₂O→Si(OH)₄+4(C₂H₅OH—) (1)

For silica aerogel containing low temperature insulation, the currently preferred ingredients are tetraethoxysilane (TEOS), water, and ethanol (EtOH). The preferred ratio of TEOS to water is about 0.2-0.5:1, the preferred ratio of TEOS to EtOH is about 0.02-0.5:1, and the preferred pH is about 2 to 9. The natural pH of a solution of the ingredients is about 5. While any acid may be used to obtain a lower pH solution, HCl, H₂SO₄ or HF are currently the preferred acids. To generate a higher pH, NH₄OH is the preferred base.

### Gel Formation

Generally, gels may be formed via maintaining the mixture in a quiescent state for a sufficient period of time, changing the pH of the solution, altering the temperature, directing a form of energy onto the mixture, or a combination thereof. Exemplary forms of energy include: a controlled flux of electromagnetic (ultraviolet, visible, infrared, microwave), acoustic (ultrasound), or particle radiation. Fillers may be dispensed in the gel precursor solution at any point before a gel is formed. Gel formation may be viewed as the point where a solution (or mixture) exhibits resistance to flow and/or forms a continuous polymeric network throughout its volume. Preferably the mixture comprising fillers and precursors is a homogenous solution, conducive to gel formation.

Use of a Mold

A mold may be used to cast the aerogel composites of the present invention into desired shapes. One benefit of using a mold may be an improved aesthetic appearance. Another benefit may be the creation of features difficult to produce after casting without damage to the material. Such features include: holes, depressions, protrusions and patterns, for example, to allow for a better fit between the aerogel composite material and a supporting structure. Reinforced aerogel materials previously described can also be incorporated into this molding procedure.

Gel Aging

Gels may be aged prior to gel drying to further strengthen the gel structure. In general, this step aids in further cross-linking the gel structure and can be useful for preventing potential volume loss during drying, or simply producing a stronger final gel. Aging can involve: maintaining the gel (prior to drying) at a quiescent state for an extended period of time, addition of cross-linkage promoting compounds or both. Aging time may take as long as days or even week, or as short as less than one day. Typically, for forming an aerogel monolith, aging is for a sufficiently long period (commonly overnight) so that a condensation reaction (as shown in Eq. 2) occurs.

Si(OH)₄→SiO₂+2H₂O (2)

Gel Drying

Drying plays an important role in engineering the properties of aerogels, such as porosity and density which influence the material thermal conductivity. Methods of drying gels for generating aerogels or xerogels are well known, and, to date, numerous methods of drying have been explored. Kistler ((1932) J. Phys. Chem. 36: 52-64) describes a drying process where the gel solvent is maintained above its critical pressure and temperature. Due to the absence of any capillary forces, such supercritical drying maintains the structural integrity of the gel. U.S. Pat. No. 4,610,863 describes a process where the gel solvent is exchanged with liquid carbon dioxide and subsequently dried at conditions where carbon dioxide is in a supercritical state. Such conditions are milder than the one described by Kistler. U.S. Pat. No. 6,670,402 teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. Methods of drying may also be found in U.S. Pat. Nos. 4,873,218 and 5,476,878. Finally, U.S. Pat. No. 5,565,142, herein incorporated by reference, describes subcritical drying techniques and a process whereby the gel surface is modified such that it is more hydrophobic and stronger so that it can resist collapse of the structure during ambient or subcritical drying. Products obtained from such ambient pressure or subcritical drying are often referred to as xerogels. The ability to dry the sol-gel is in part dependent on the size of the foam. A larger foam may require more intensive drying because of the longer distance the solvent must pass from the interior of the foam to the exterior. A sol-gel that is dried in a mold or container may require that the liquid travel through the sol-gel to the open surface of the mold or container in order for the liquid component to be removed. The embodiments of the present invention can be practiced with drying using any of the above techniques. In some embodiments, it is preferred that the drying is performed at vacuum to below super-critical pressures (pressures below the critical pressure of the fluid present in the gel at some point) and optionally using surface modifying agents.

Surface Treatment

Aerogels may be surface treated to impart or improve hydrophobicity. Hydrophobing treatment may be carried out by reacting a hydroxy moiety of a silanol group present on a surface of the wet-gel compound with a functional group of a hydrophobing agent to thereby convert the silanol group into a hydrophobic group of the hydrophobicity-imparting agent. For example, the hydrophobing treatment may be carried out by immersing a gel in a hydrophobicity-imparting solution of a hydrophobing agent in a solvent, and mixing the gel and the solution to allow the hydrophobicity-imparting agent to permeate the gel, possibly including heating such a gel mixture so that a hydrophobicity-imparting reaction occurs. Examples of solvents for use in hydrophobing treatment include methanol; ethanol; isopropanol; xylene; toluene; benzene; N,N-dimethylformamide; hexamethyldisiloxane; and the like. There is no particular limit in selection of the solvent, as long as the solvent permits the hydrophobing agent to impart hydrophobicity to a gel.

Surface treatment may occur prior to or after gel drying. Preferably, when surface treatment occurs prior to gel drying, the solvent used in hydrophobing treatment facilitates drying (e.g., methanol, ethanol, isopropanol, liquefied carbon dioxide, or the like), or is easily replaceable by such. Examples of hydrophobing agents include hexamethyldisilazane, hexamethyldisiloxane, trimethylmethoxysilane, dimethyldimethoxysilane, methyltrimethoxysilane, ethyltrimethoxysilane, trimethylethoxysilane, dimethyldiethoxysilane, methyltriethoxysilane, and the like. Surface treatment may facilitate drying, and enhance or help maintain properties, such as transparency or translucency.

Some Alternative Methods

Alternatively, any of the following/foregoing methods can be utilized to make an aerogel composite article of this invention, but the methods that allow for obtaining the lowest density and/or best thermally insulating articles are preferred. For example, in a first alternative implementation of gel making, a water soluble, basic metal oxide precursor can be gelled by acidification in water to make a hydrogel. Sodium silicate has been widely used for this purpose. Salt by-products may be removed from the silicic acid precursor by ion-exchange and/or by washing subsequently formed gels with water. Removing the water from the pores of the gel can be performed via exchange with a polar organic solvent such as ethanol, methanol, or acetone. The resulting dried aerogel has a structure similar to that directly formed by supercritical extraction of gels made in the same organic solvent. A second alternative method entails reducing the damaging capillary pressure forces at the solvent/pore interface by chemical modification of the matrix materials in their wet gel state via conversion of surface hydroxyl groups to tri-methylsilylethers (see U.S. Pat. No. 5,877,100, for example) to allow for drying of the aerogel materials at temperatures and pressures below the critical point of the solvent.

### Aerogel-Open Cell Foam Composite

To produce a composite of aerogel-open cell foam, any appropriate method may be used. As a non-limiting example, a section of open cell foam may be placed in a walled container, or mold. 1300 ml of a pre-hydrolyzed silica precursor may be mixed with 1700 ml of denatured alcohol, 95% and stirred for 15 min. The solution may then be gelled by the slow addition of HF (2% by volume of the total solution) with stirring. The resulting solution may then be poured on the open cell foam previously placed in a container. After gelation, the resulting gel-foam is aged overnight in a sealed bath of ethanol at 50° C. The alcohol trapped in the gel is removed by subcritical and supercritical CO₂ extraction over the span of four days.

### Laminates

In another embodiment of this invention, an aerogel-open cell foam composite is used in the form of a multi-layer laminate. In addition to including an aerogel-open cell foam composite, the laminates may include layers of materials which will help provide specific characteristics to the final composite structure. For example, the inclusion of a metal layer in the x-y plane, such as a copper mesh, can improve x-y thermal and/or electrical conductivity, RFI-EMI attenuation, the ability to anchor the composite to a support structure, and/or provide additional physical strength. While any metal can be used to produce the metal mesh, copper and stainless steel are currently preferred. Suitable meshes will be made from wires having diameters ranging from about 0.001 to 0.1 inches, preferably about 0.01 to 0.05, and the wire spacing may range from as tight as a window screen to 0.3 inches.

When the additional layer is of a high (>1 W/m-K) thermal conductivity material such as a carbon fiber, silicon carbide, or a metal, the resulting composite has been found to exhibit a significantly enhanced ability to rapidly dissipate heat throughout the x-y plane of a multilayer composite, further improving the durability of the composite under a high heat load.

While these laminates are shown to be symmetric, this is preferred and not mandatory.

When a metal mesh is used as one or more of the central layers, it also offers the benefit of producing an aerogel composite material which is not only drapable or flexible, but is also conformable, i.e. it can retain its shape after bending.

Other approaches to couple the high conductivity layer into the composite include a metal sheet where portions of the sheet are cut and bent out of plane. These bent portions serve as an anchor between the conductive layer and the rest of the composite. Metal foil strips may be similarly utilized, as may a combination of such materials.

The conductive layer has a number of secondary benefits. Aerogel composites containing metal conductive layers, may be deformed to conform to a shape and hold that shape. The composite can be deformed to both simple and complex curvatures. It can spring back to a limited extent but also effectively plastically deformed to hold a shape. Another benefit of the conductive layer is that it commonly consists of structural fibers—strong and continuous. This conductive layer can serve as an anchoring material through which mechanical fasteners may be driven. The fasteners would grip onto composite or the conductive layer itself.

Mechanical loads experienced by the composite can be transmitted through a metal conductive layer to the fastener and into other structures. An example of this would be fastening the aerogel composite onto a vehicle chassis to serve as a heat barrier. If the reinforcement is adequately magnetized, it may be attached to a ferrous or magnetic structure without the need of mechanical fasteners. The heat transmitted by the conductive layer can be either dumped to the environment and/or a beat sink (radiation, convection) or used to run secondary processes. For example, excess heat may be used directly (heating water, etc.) or converted into electrical energy through a Peltier element or the like. The design of the aerogel composite can be such that the hot side of the blanket has a conductive layer near the surface that directs heat flux to the cold side of the blanket only at points where Peltier elements are placed. Examples of high thermal conductivity fibers include graphite, silicon carbide, copper, stainless steel, aluminum, and the like.

Gel Sheets Manufacturing

Another way to manufacture aerogel-open cell foam composites is to first make gel sheets i.e. wet gel sheets with foam reinforcement as a continuous sheet or in discrete segments and subsequently dry them using various methods.

An embodiment involves a conveyor based system that utilizes delivery of gel precursors (including catalyzed silica sols in a preferred embodiment) on one end of a conveyor and combine that with a continuous foam sheet to make a continuous gel sheet which may be wound in a plurality of layers (preferably around a mandrel with a uniform tension) and processed in subsequent chemical treatment, ageing and drying steps. When it is wound, additional layers may be introduced between the gel sheet layers. Such additional layers (sometimes referred to as separator layer) may be impermeable (preferably impermeable to fluids at pressures below 1 psi, 5 psi or 10 psi) or permeable. Permeable layers may be in the form of perforated plastic sheets, or mesh like material, perforated foil or the like. Such wound layers in roll form may be further treated (in a preferred embodiment surface treated) with silylating agents such as siloxanes, hexamethyldisilazane, hexamethyldisiloxane, various aminosilanes and/or various halosilanes. Optionally wound gel sheet rolls may be aged for a period of time. During such period, a fluid composition may be allowed to flow through/around the gel sheet rolls. Preferably, they are led to flow parallel to the layers. Optional additional layers introduced in the gel sheet roll may facilitate better fluid flow and better fluid-gelsheet accessibility. Fluid compositions used may be as simple as solvents such as water, alcohols, acetone, ethers etc or their combinations or as complex as silylating agents, basic materials, acidic materials, or any other chemicals that will render the gel sheets a specific performance enhancement. Gel sheet rolls after or before ageing may be dried under many conditions such as ambient pressure and slightly elevated temperature drying, or dying using supercritical fluids, drying under supercritical conditions and any condition in between ambient to supercritical environments such as subcritical drying etc. Dried gel sheets (or aerogel composite sheets) may be further heat treated for a period of 1 minute to 60 minute at a temperature of 25° C. to 400° C.

Alternatively, gel sheets may be cut into specified sizes instead of them being wound into rolls. In another alternative way, gel sheets may be cut after optional aging, chemical treatment (such as silylation) or after drying or after heat treatment into specified size pieces.

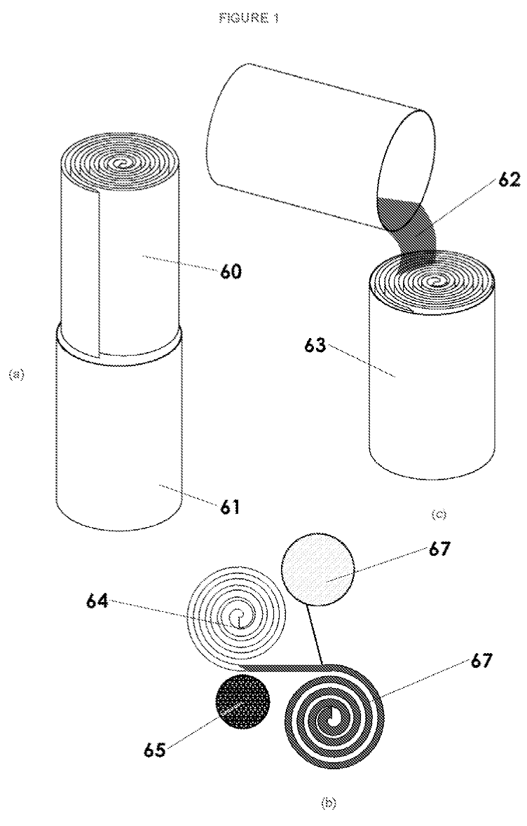

In yet another embodiment whose preferred embodiment is illustrated in FIG. 1, open-cell foam material in a sheet form of a definite length may be rolled into plurality of layers as a preform roll (60). Additional layers (sometimes referred to as separator layer) may be co-rolled in such perform roll. Such additional layers may be impermeable (preferably impermeable to fluids at pressures below 1 psi, 5 psi or 10 psi) or permeable. Permeable layers may be in the form of perforated plastic sheets, or mesh like material, perforated foil or the like. Gel precursors (62) (including catalyzed silica sols in a preferred embodiment) may be infused or combined with the foam sheet in the perform roll. Additionally, any additional layer incorporated beforehand in the perform roll may be replaced with n additional layer of different kind prior to any additional treatment to the perform roll. This may include replacing impermeable layer (66) with a permeable layer (65) and vice versa. Such perform rolls (63) may be further treated with silylating agents such as siloxanes, hexamethyldisilazane, hexamethyldisiloxane, various aminosilanes and/or various halosilanes. Optionally wound gel sheet rolls may be aged for a period of time. During such period, a fluid composition may be allowed to flow through/around the gel sheet rolls. Preferably, they are led to flow parallel to the layers. Optional additional layers introduced in the gel sheet roll may facilitate better fluid flow and better fluid-gelsheet accessibility. Fluid compositions used may be as simple as solvents such as water, alcohols, acetone, ethers etc or their combinations or as complex as silylating agents, basic materials, acidic materials, or any other chemicals that will render the gel sheets a specific performance enhancement. Gel sheet rolls after or before ageing may be dried under many conditions such as ambient pressure and slightly elevated temperature drying, or dying using supercritical fluids, drying under supercritical conditions and any condition in between ambient to supercritical environments such as subcritical drying etc. Dried gel sheets (or aerogel composite sheets) may be further heat treated for a period of 1 minute to 60 minute at a temperature of 25° C. to 400° C. Any of the processing mentioned may be performed within a contained space (61)

Foams used in several embodiments of the instant invention may be shaped to any three dimensional form allowing for the resultant aerogel composite to be in any possible shape in which one can make the foam reinforcement. Additionally, any kind of pattern, slitting or openings or holes may be present in the open-cell foam to provide additional flexibility or ability to handle in a robust way. In yet another preferred embodiment, a spiral like structure may be carved from a foam object which may be reinforced with gel precursors, optionally surface treated (or silylated), optionally aged and dried. After drying such spiral structure reinforced aerogel composites may have an inherent tendency to close back making it suitable to conform to curved surfaces like pipes or tanks. The curvature of the spiral reinforcement foam may be adjusted.

### Other Applications

Aerogel-open cell foam composites and aerogel-reticulated foam composites and laminates made there from have a number uses and applications including, but not limited to, thermal barriers and panels (including fire barriers and panels) and insulation (including in apparel, such as coats, pants, socks, shirts, hats, gloves, mittens, shoes, boots, facemasks, undergarments, and the like; as well as in buildings, and other insulation needs such as piping of oil or natural gas), acoustical barriers and insulation, curtain walls, mobile partitions, facades, electrical and electronic components, shock and impact isolators, and chemical applications. Applications utilizing the composites of the invention may use single or multiple layers of the composites, and may mechanically alter composites of the invention such as through cutting them to size.

Transparent Assemblies

Translucent and transparent aerogel-foam composites as well as translucent and transparent laminates made there from have additional uses, such as use as a translucent or transparent panel, preferably taking advantage of additional properties of the material, such as its low thermal conductivity or flexibility. Translucent or transparent panels as well as translucent and transparent laminates made there from have numerous uses, for example as windows or as a thermally insulating component of a window, such uses include, but are not limited to parallel transparent panes, double glass window panels, double glass window panels with an intermediate aerogel-foam composite component, multipane glazing units, vehicle window, optically transparent glass sandwiches with an intermediate aerogel-foam composite component, or the like with a spacer, preferably a spacer such as that described in U.S. Patent Application Ser. No. 60/744,087. Further, translucent or transparent panels as well as translucent and transparent laminates made there from, can be used as transparent lamina for mounting over a window opening, in a light table, or as a stove door or stove window, or freezer door or freezer window, or generally transparent means permitting an interior view or means for inspecting or viewing, for example a transparent flow-line section (pipe where flow can be viewed). Translucent or transparent panels as well as translucent and transparent laminates made there from, can be used as walls, for example in a greenhouse; as optically protective gear, such as a face or eyeshield; as or as a component of curtain walls, mobile partitions, or facades; as a translucent or transparent layer, base, package or wrapping, envelope, enclosure, enclosure for a light source, or enclosure with hermetic seal; or as a flexible sheet or fire panel.

For the sake of discussion, assemblies according to these embodiments are described in applications involving windows, and it is recognized that such assemblies are equally applicable to other architectural units, appliances, vehicles and any other application requiring optical transparency and acoustic or thermal insulation assemblies.

Aerogel-foam composites described in the present invention can be faced with a variety of materials such as, but not limited to, transparent or translucent glass and plastics for construction of light permeable insulating assemblies. Non-limiting examples of transparent/translucent plastics are: polycarbonates, acrylics, polyethylenes, polypropylenes, cellulose acetate butyrates, glycol modified polyethylene terephthalates, polyvinyl chlorides or a combination thereof. Types of glass suitable for embodiments of this invention generally include all commonly used glass in architectural applications, appliances (such as stoves, refrigerators, etc.) and the like. Examples include soda-lime glass and stove glass. For applications requiring high transmission of light such as for solar panels, low-iron content glass is preferred. Generally glass with less than 10% iron content is preferred, where examples include clear glass, float glass, container glass, flint glass, optical glass, borosilicate glass, crystal glass, and a host of others.

In a similar fashion to single, double or other multiple-glazed windows, the aerogel-foam composites of the present invention can be sandwiched between or attached to transparent or translucent materials. Typically spacers are placed in the perimeter region between each glazing and glued (sealed) thereto, thereby securing the aerogel material in between. Such assemblies are very useful for oven/refrigerator windows, doors, sky lights, partitions and any other instances where visible light transmittance into or out of a thermally insulated area is desired. Specific examples of methods to produce windows and similar structures with an insulating glazing can be found in U.S. Pat. No. 4,270,322, hereby incorporated by reference.

In one embodiment, an assembly comprises a layer of translucent aerogel-foam composite, which is placed between two glazings (herein referred to as “support members”). The support members provide most of the mechanical support for the entire assembly. That is, the aerogel layer may or may not provide any mechanical support to the overall assembly. The, support members are transparent to light in the visible spectrum and positioned such that their respective surfaces are in a parallel configuration thereby defining a gap there between where the aerogel material is placed. Furthermore, the support members may be fixed in an arrangement which does not necessitate any fastening means. For example, a railing or groove where each glazing is fastened into is used. Alternatively, the support members are glued to a spacer placed there between at the perimeters. As yet another alternative, a frame is fixed to the edge of the support members thereby securing the same. However, these methods may also be combined. In a related embodiment, said assembly exhibits overall a better than 10%, better than 20%, better than 30%, better than 40%, better than 50%, better than 60%, better than 70% better than 80% or better than 90% transmission of light in the visible spectrum. The support members may be chosen such that other ranges of light (e.g., infrared, ultraviolet, etc.), for instance from solar radiation is transmitted. However, it may be desired to block out some of the ranges (e.g., UV) by incorporating an external glazing or coating that absorbs or reflects light in undesired ranges of the spectrum.

These assemblies are highly effective for methods employing efficiently solar energy use. For instance, a skylight constructed from the aerogel-foam composites or laminates made therefrom described can enable heating of the interior of a closed area with solar radiation while preventing heat from escaping. Additionally, a phase change materials can be used in conjunction with the aerogel-foam composite-insulated assemblies. A case in example is a climate such as that of a desert region where daily temperature swings are very large. A phase change material on the interior surface of the assembly can be translucent and allow the solar radiation through into the interior of building during daytime. As the interior begins to warm up, the phase change material will absorb a portion of the heat and store the energy in the form of a new phase. This has the advantage of ensuring the interior area is not excessively heated and that the energy is stored for later use. During the evening, or when the interior starts to cool, the phase change material will emit the stored heat by changing back to the original phase. The aerogel material ensures that the stored and re-radiated heat is not lost to the exterior.

Solar water heaters can also benefit tremendously from the present invention (see, for example, U.S. patent application Ser. No. 11/392,925, hereby incorporated by reference). The insulation in the solar water heater can be replaced with an aerogel-open cell foam composite, and the glazing may be replaced with an assembly, such as a transparent aerogel-open cell foam composite between glazings, or an aerogel-open cell foam composite as per embodiments of the present invention.

Aerogel-foam composites of the invention may act as filters, absorbing light and/or electromagnetic radiation of at least one wavelength. Aerogel-foam composites of the invention may also act as diffusers, diffusing incident light and/or electromagnetic radiation, and/or as light modifiers reflecting or refracting light and/or electromagnetic radiation.

In another embodiment, translucent aerogel-foam composites of the invention may contain an object or image within them, for example a flexible display image (see U.S. Pat. No. 4,619,876).

### EXAMPLES

### Example 1

### Aerogel-Open Cell Polyurethane Foam Composite

¼″ thick polyurethane (PU) open cell foams and a non-opacified silica sol were used to prepare aerogel-foam composites. Denatured ethanol was added to dilute NH₃ in H₂O (28-30%). This solution was added to a silica precursor that was also diluted with denatured ethanol. The silica precursor contained hydrolyzed tetraethoxyorthosilicate (TEOS), water, and ethanol. The combined solution was poured into polyurethane foam (4″×4″×0.25″) of varying porosities. The gelled samples were aged in an hexamethyldisilazane (HMDS) ethanolic solution at 55° C. for ˜16 hours and extracted under supercritical conditions to generate an aerogelized-polyurethane foam composite. The thermal conductivities and densities of the aerogel-open cell polyurethane foam composites were determined at ambient temperature. The resulting aerogel-open cell polyurethane foam composites are flexible and translucent.

Various embodiments described herein may be combined with various other embodiments of the instant invention unless stated otherwise. Such modular nature of the embodiments is to be understood to make new combinations and obvious variations without much effort.

While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

All references, including publications, patent applications, and patents, cited herein are hereby incorporated by reference to the same extent as if each reference were individually and specifically indicated to be incorporated by reference, whether previously specifically incorporated or not, and were set forth in its entirety herein.

The terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Citation of documents herein is not intended as an admission that any is pertinent prior art. All statements as to the date or representation as to the contents of documents is based on the information available to the applicant and does not constitute any admission as to the correctness of the dates or contents of the documents.

What is claimed is:

1. A flexible aerogel-open cell foam composite, comprising at least one open cell foam component and at least one aerogel matrix.

2. A flexible aerogel-open cell foam composite of claim 1, wherein the open cell foam component of said flexible aerogel-open cell foam composite has a pore size greater than 50 microns or wherein the open cell foam is a coarse cell foam.

3. A flexible aerogel-open cell foam composite of claim 1, wherein the open cell foam component of said flexible aerogel-open cell foam composite is a coarse cell foam.

4. A flexible aerogel-open cell foam composite of claim 1, wherein the open cell foam component of said flexible aerogel-open cell foam composite is at least about 10% open cell foam or preferably at least 50% open cell foam.

5. A flexible aerogel-open cell foam composite of claim 1, wherein the open cell foam component of said flexible aerogel-open cell foam composite is at least about 80% open cell foam or preferably at least 85% open cell foam.

6. A flexible aerogel-open cell foam composite of claim 1, wherein said open cell foam component is a polyolefin foam, a polyurethane foam, a rebond foam or a combination thereof.

7. A flexible aerogel-open cell foam composite of claim 1, wherein said aerogel matrix is based on a material selected from the group consisting of: silica, alumina, titania, zirconia, yttria, hafnia, or a combination thereof.

8. A flexible aerogel-open cell foam composite of claim 1, wherein said flexible aerogel-open cell foam composite has a thermal conductivity of less than about 50 mW/mK, less than about 25 mW/mK or less than about 20 mW/mK.

9. A flexible aerogel-open cell foam composite of claim 1, wherein said flexible aerogel-open cell foam composite has a density of less than about 0.150 g/cc, less than about 0.125 g/cc, less than about 0.120 g/cc, less than about 0.115 g/cc, less than about 0.110 g/cc 0r less than about 0.1 g/cc

10. A flexible aerogel-open cell foam composite of claim 1, wherein said flexible aerogel-open cell foam composite transmits incident light by at least about 10%, 20%, 30% or 50%.

11. A flexible aerogel-open cell foam composite of claim 1, additionally comprising one or more fillers, optionally wherein the largest dimension of said fillers is less than about 100 μm.

12. A flexible aerogel-open cell foam composite of claim 23, wherein said flexible aerogel-open cell foam composite comprises less than about 50% by weight metal silicate filler.

13. A flexible aerogel-open cell foam composite of claim 25, wherein at least one of said metal silicate fillers is a wollastonite.

14. A flexible aerogel-open cell foam composite of claim 23, wherein at least one of said fillers is a microfiber.

15. A flexible aerogel-open cell foam composite of claim 1, additionally comprising an Fe-containing compound, a Mn-containing compound or a Cu-containing compound dispersed within said aerogel-open cell foam composite.

16. A flexible aerogel-open cell foam composite of claim 1, wherein said flexible aerogel-open cell foam composite is encapsulated.

17. A flexible aerogel-open cell foam composite of claim 1, wherein said flexible aerogel-open cell foam composite is sealed with a sealant.

18. The flexible aerogel-open cell foam composite of claim 1, wherein the aerogel matrix is continuous.

19. An optically translucent and thermally insulating assembly comprising:
at least two planer support members capable of transmitting light, positioned facing each other and spaced thereby defining a gap there between; and
at least one continuous layer of aerogel-open cell foam composite of claim 1 positioned within said gap and secured between said support members, said aerogel-open cell foam composite having optical transmittance of at least about 60% in the visible spectrum.

20. The assembly of claim 19 wherein the aerogel-open cell foam composite does not rupture below about 16.2% flexural strain.

21. The assembly of claim 19 wherein the support members comprise a glass material containing less than about 10% iron.

22. The assembly of claim 19 wherein the support members comprises a polymer selected from a group consisting of: polycarbonates, acrylics, polyethylenes, polypropylenes, cellulose acetate butyrates, glycol modified polyethylene terephthalates, polyvinyl chlorides, and a combination thereof.

23. An optically transparent and thermally insulating assembly comprising:
at least two planer support members capable of transmitting light, positioned facing each other and spaced thereby defining a gap there between; and
at least one continuous layer of aerogel-open cell foam composite of claim 1 positioned within said gap and secured between said support members.

24. The assembly of claim 23 wherein said assembly has an optical transmission of at least about 30% in the visible spectrum.

25. A heated and insulated containment system with an internal volume defined by at least three walls wherein at least one of said three walls comprises:
at least two planer support members capable of transmitting light, positioned facing each other and spaced thereby defining a gap there between; and
at least one continuous layer of aerogel-open cell foam composite of claim 1 positioned within said gap and secured between said support members, said aerogel-open cell foam composite having optical transmittance of at least about 60% in the visible spectrum thereby allowing solar radiation to substantially enter said internal volume.

26. A method of preparing an aerogel-open cell composite material of claim 1 comprising the steps of:
Forming a gel from a mixture comprising gel precursors and an open cell foam; and
drying the gel.

27. The method of claim 26 comprising the step of dispensing an amount of fillers into a gel precursor solution, thereby forming said mixture.

28. The method of claim 26 further comprising the step of dispensing the mixture comprising fillers and gel precursors, into an open cell foam.

29. The method of claim 26 further comprising the step of dispensing the mixture comprising fillers and gel precursors, into an open cell foam wherein, said open cell foam has a pore size greater than 50 micron or said open cell foam is a coarse cell foam.

30. The method of claim 26 further comprising the step of dispensing the mixture comprising fillers and gel precursors, into an open cell foam wherein, said open cell foam is a reticulated foam.

31. The method of claim 26 further comprising the step of dispensing the mixture comprising fillers and gel precursors, into an open cell foam wherein, said open cell foam is a polyolefin foam or a polyurethane foam.

32. The method of claim 26 wherein the gel is dried using a supercritical fluid.

33. The method of claim 26 wherein the gel is dried using a supercritical carbon dioxide.

34. A method of preparing an aerogel-open cell composite material of claim 1 comprising the steps of:
providing an open-cell foam in a sheet form;
combining an aerogel precursor with the open-cell foam;
gelling the precursor in the open-cell foam to form a gel sheet; and
drying the gel sheet.

35. The method of claim 34 wherein drying is performed using supercritical fluids.

36. The method of claim 34 further comprising the step of rolling the gel sheet into plurality of layers before drying.

37. The method of claim 36 further comprising the step of providing an additional separator layer between gel sheet layers.

38. The method of claim 36 wherein separator layer is permeable.

39. The method of claim 36 wherein separator layer is impermeable.

40. The method of claim 36 wherein separator layer is a fluid layer.

41. A method of preparing an aerogel-open cell composite material of claim 1 comprising the steps of:
providing an open-cell foam of definite length in a sheet form;
rolling the foam into plurality of layers to make a preform;
combining an aerogel precursor with the open-cell foam in the preform;
gelling the precursor in the perform to make gel sheet in the form of plurality of layers; and
drying the gel sheet.

42. The method of claim 41 wherein drying is performed using supercritical fluids.

43. The method of claim 41 further comprising the step of providing an additional separator layer between gel sheet layers.

44. The method of claim 43 wherein separator layer is permeable.

45. The method of claim 43 wherein separator layer is impermeable.

46. The method of claim 43 wherein separator layer is a fluid layer.
